(19) United States
(12) Patent Application Publication
(10) Pub. No.: US 2021/0037518 A1
(43) Pub. Date: Feb. 4, 2021

(54) USER APPARATUS AND BASE STATION APPARATUS

(71) Applicant: NTT DOCOMO, INC., Tokyo (JP)

(72) Inventors: Hideyuki Moroga, Chiyoda-ku, Tokyo (JP); Yuki Matsumura, Chiyoda-ku, Tokyo (JP); Satoshi Nagata, Chiyoda-ku, Tokyo (JP); Yuichi Kakishima, Palo Alto, CA (US)

(73) Assignee: NTT DOCOMO, INC., Tokyo (JP)

(21) Appl. No.: 16/966,958

(22) PCT Filed: Mar. 30, 2018
(86) PCT No.: PCT/JP2018/013994

§ 371 Date: Aug. 3, 2020

(51) Int. Cl. H04W 72/04

(52) U.S. Cl. CPC H04W 72/0413

(57) ABSTRACT

A user apparatus includes a processing unit configured to determine a density with which a phase correction reference signal corresponding to a data channel including control information is arranged in a physical resource and a transmission unit configured to transmit a radio signal including a physical resource, in which the phase correction reference signal with the determined density and the data channel including the control information are arranged, to a base station apparatus.

### TECHNICAL FIELD

The present invention relates to a user apparatus and a base station apparatus in a wireless communication system.

### BACKGROUND ART

In 3rd Generation Partnership Project (3GPP), in order to implement a further increase in system capacity, a further increase in data transmission speed, further reduction in delay in a radio section, or the like, a wireless communication scheme called 5G or New Radio (NR) (hereinafter the wireless communication scheme is referred to as “NR”) is being discussed. In NR, various wireless techniques are being discussed in order to satisfy requirements that a delay in a radio section be 1 ms or less while achieving the throughput of 10 Gbps or more. In NR, regarding a demodulation reference signal (DM-RS), in order to reduce a processing time required for channel estimation and signal demodulation, arranging the demodulation reference signal at a front position in a time domain within a slot is being discussed. The demodulation reference signal arranged at the front position is referred to as a front-loaded DM-RS. In NR, in addition to the front-loaded DM-RS, a DM-RS located at the back position in the time domain in the slot is referred to as an additional DM-RS. In NR, introduction of a phase tracking reference signal (PT-RS) which is a reference signal for phase fluctuation correction for reducing influence of a phase noise and the like is being discussed (for example, Non-Patent Document 1).

### CITATION LIST

### Non-Patent Document

Non-Patent Document 1: 3GPP TS 38.211 V15.0.0 (2017 December)

### SUMMARY OF THE INVENTION

### Problem to be Solved by the Invention

In NR, when uplink control information (UCI) is transmitted from a user apparatus to a base station apparatus via a Physical Uplink Shared Channel (PUSCH), in a case in which an arrangement of the reference signal of the PUSCH is not changed, an error rate when only a data signal is transmitted is equal to an error rate when a control signal is transmitted as well. However, generally, the control signal requires a lower error rate than the data signal, and thus a required error rate is unable to be achieved.

The present invention was made in light of the foregoing, and it is an object of the present invention to provide a technique capable of arranging an appropriate reference signal in a data channel in a case in which a control signal is transmitted through the data channel in a wireless communication system.

### Means for Solving Problem

According to the technology of the disclosure, provided is a user apparatus including a processing unit configured to determine a density with which a phase correction reference signal corresponding to a data channel including control information is arranged in a physical resource and a transmission unit configured to transmit a radio signal including a physical resource, in which the phase correction reference signal with the determined density and the data channel including the control information are arranged, to a base station apparatus.

### Effect of the Invention

According to the disclosed technique, it is possible to arrange an appropriate reference signal in a data channel in a case in which a control signal is transmitted through the data channel in a wireless communication system.

### BRIEF DESCRIPTION OF DRAWINGS

FIG. 1 is a diagram illustrating a configuration example of a wireless communication system in an embodiment of the present invention;

FIG. 2 is a diagram illustrating an example (1) in which a PT-RS is arranged in a physical resource in an embodiment of the present invention;

FIG. 3 is a diagram illustrating an example (2) in which a PT-RS is arranged in a physical resource in an embodiment of the present invention;

FIG. 4 is a diagram illustrating an example (3) in which a PT-RS is arranged in a physical resource in an embodiment of the present invention;

FIG. 5 is a diagram illustrating an example (4) in which a PT-RS is arranged in a physical resource in an embodiment of the present invention;

FIG. 6 is a diagram illustrating an example (5) in which a PT-RS is arranged in a physical resource in an embodiment of the present invention;

FIG. 7 is a diagram illustrating an example of a functional configuration of a base station apparatus 100 in an embodiment of the present invention;

FIG. 8 is a diagram illustrating an example of a functional configuration of a user apparatus 200 in an embodiment of the present invention; and

FIG. 9 is a diagram illustrating an example of a hardware configuration of each of the base station apparatus 100 and the user apparatus 200 in an embodiment of the present invention.

### MODE(S) FOR CARRYING OUT THE INVENTION

Hereinafter, an embodiment of the present invention will be described with reference to the appended drawings. Note that the following is an example, and an embodiment to which the present invention is applied is not limited to the following embodiment.

In an operation of a wireless communication system according to an embodiment of the present invention, existing technology is appropriately used. Here, the existing technology is, for example, existing LTE but not limited to existing LTE. Further, the term “LTE” used in this specification shall have a broad meaning including LTE-Advanced and a scheme subsequent to LTE-Advanced (for example, NR or 5G) unless otherwise set forth herein.

Further, in an embodiment of the present invention to be described below, terms such as a synchronization signal (SS), a primary SS (PSS), a secondary SS (SSS), a physical broadcast channel (PBCH), and a physical RACH (PRACH) used in existing LTE are used. This is for the sake of convenience of description, signals, functions, or the like similar to them may be referred to as other names.

Further, in an embodiment of the present invention, a duplex scheme may be a time division duplex (TDD) scheme, a frequency division duplex (FDD) scheme, or any other scheme (for example, a flexible duplex or the like).

Further, in the following description, transmitting a signal using a transmission beam may be performed by transmitting a signal which is multiplied by a precoding vector (which is precoded with a precoding vector). Similarly, receiving a signal using a reception beam may be performed by multiplying a received signal by a predetermined weight vector. Further, transmitting a signal using a transmission beam may be expressed as transmitting a signal through a specific antenna port. Similarly, receiving a signal using a reception beam may be expressed as receiving a signal through a particular antenna port. An antenna port refers to a logical antenna port or a physical antenna port defined in the 3GPP standard.

A method of forming the transmission beam and the reception beam is not limited to the above method. For example, in the base station apparatus 100 and the user apparatus 200 having a plurality of antennas, a method of changing an angle of each antenna may be used, a method in which a method using a precoding vector and a method of changing an angle of an antenna are combined may be used, a method of switching and using different antenna panels may be used, a method of using a combination of a plurality of antenna panels may be used, or any other method may be used. Further, for example, a plurality of different transmission beams may be used in a high frequency band. Using a plurality of transmission beams is referred to as a multi-beam operation, and using a single transmission beam is used is referred to as a single beam operation.

Further, in an embodiment of the present invention, when a wireless parameter or the like is “configured,” it may mean that a predetermined value is pre-configured or specified or it may mean that a wireless parameter indicated by a base station apparatus 100 or a user apparatus 200 is configured.

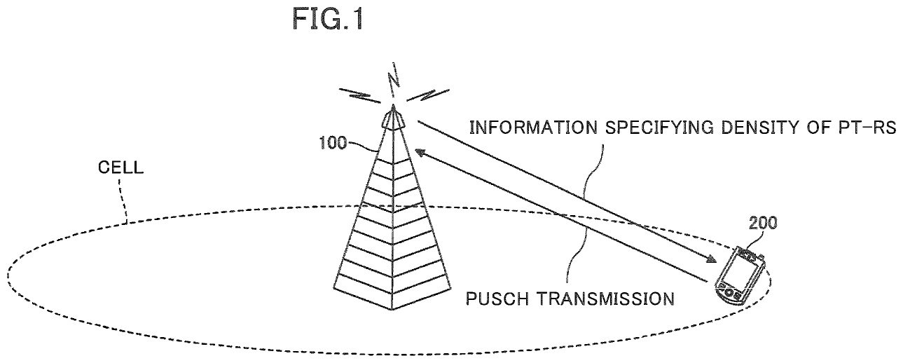

FIG. 1 is a diagram illustrating a configuration example of a wireless communication system in an embodiment of the present invention. A wireless communication system according to an embodiment of the present invention includes a base station apparatus 100 and a user apparatus 200 as illustrated in FIG. 1. In FIG. 1, one base station apparatus 100 and one user apparatus 200 are illustrated, but this is an example, and a plurality of base station apparatuses 100 and a plurality of user apparatuses 200 may be installed.

The base station apparatus 100 is a communication device that provides one or more cells and performs wireless communication with the user apparatus 200. The base station apparatus 100 transmits a reference signal to the user apparatus 200, and the user apparatus 200 transmits a reference signal to the base station apparatus 100. The reference signal is arranged in a predetermined orthogonal frequency division multiplexing (OFDM) symbol on a physical resource in which a control signal and a data signal are arranged. Examples of the reference signal include a demodulation reference signal (DM-RS), a phase noise tracking reference signal (PT-RS), and a channel status information-reference signal (CSI-RS). A physical resource of a radio signal is defined by the time domain and the frequency domain, the time domain may be defined by the number of OFDM symbols, and the frequency domain may be defined by the number of subcarriers or the number of resource blocks.

Both the base station apparatus 100 and the user apparatus 200 can perform beamforming and perform transmission and reception of signals. The user apparatus 200 is a communication device having a wireless communication function such as a smartphone, a mobile phone, a tablet, a wearable terminal, or a communication module for Machine-to-Machine (M2M), and establishes a wireless connection with the base station apparatus 100 and uses various types of communication services provided by the wireless communication system. The user apparatus 200 performs downlink channel estimation and downlink signal demodulation on the basis of the reference signal on the physical resource received from the base station apparatus 100, and the base station apparatus 100 performs uplink channel estimation and uplink signal demodulation on the basis of the reference signal on the physical resource received by the user apparatus 200.

As illustrated in FIG. 1, an indication of information specifying the density of the PT-RS is transmitted from the base station apparatus 100 to the user apparatus 200. The user apparatus 200 arranges the PT-RS for demodulating the NR-PUSCH in the physical resource based on the information specifying the indicated density of the PT-RS and transmits the PT-RS to the base station apparatus 100 together with the NR-PUSCH. A UCI may be included the NR-PUSCH. Hereinafter, the “NR-PUSCH” is also referred to as a “PUSCH.”

The PT-RS is a reference signal for correcting a phase noise caused by an oscillator. The density in the time domain or the density in the frequency domain with which the PT-RS is arranged in the physical resource is indicated to the user apparatus 200 by upper layer signaling for each user apparatus 200. For example, the density of the PT-RS in the time domain may change in accordance with a modulation and coding scheme (MCS). Further, for example, the density of the PT-RS in the frequency domain may change in accordance with a scheduled bandwidth.

In NR, the UCI which is an uplink control signal may be transmitted from user apparatus 200 to the base station apparatus 100 via the PUSCH. The transmission is referred to as a “UCI on PUSCH.” Here, the control signal is generally required to have a lower error rate than that of the data signal. In a case in which the same PT-RS density as a normal PUSCH is applied to the “UCI on PUSCH,” the required error rate for the UCI is unlikely to be achieved. In this regard, it is necessary to configure the PT-RS density suitable for the “UCI on PUSCH.” As the appropriate PT-RS density is configured, it is possible to achieve the required error rate in the “UCI on PUSCH.”

Table 1 illustrates a table specifying the PT-RS density in the time domain applied in the case of the “UCI on PUSCH.”

TABLE 1

| Scheduled MCS | Time density (L_{PT-RS}) |
|---|---|
| I_{MCS} < ptrs-MCS₁ | PT-RS is not present |
| ptrs-MCS₁ ≤ I_{MCS} < ptrs-MCS₂ | 4 |
| ptrs-MCS₂ ≤ I_{MCS} < ptrs-MCS₃ | 2 |
| ptrs-MCS₃ ≤ I_{MCS} < ptrs-MCS₄ | 1 |

“ptrs-MCS₁,” “ptrs-MCS₂,” “ptrs-MCS₃,” and “ptrs-MCS4” shown in Table 1 are threshold values for determining a density L_{PT-RS} in the time domain. As shown in Table 1, when an MCS “I_{MCS}” used for a PUSCH in which the UCI is transmitted is less than the threshold value “ptrs-MCS₁,” the PT-RS is not arranged. When “I_{MCS}” is greater than or equal to the threshold value “ptrs-MCS₁” and less than a threshold value “ptrs-MCS₂,” L_{PT-RS} is 4. When “I_{MCS}” is greater than or equal to the threshold value “ptrs-MCS₂” and less than a threshold value “ptrs-MCS₃,” L_{PT-RS} is 2. When “I_{MCS}” is greater than or equal to the threshold value “ptrs-MCS₃” and less than a threshold value “ptrs-MCS₄,” L_{PT-RS} is 1.

The threshold values “ptrs-MCS₁,” “ptrs-MCS₂,” “ptrs-MCS₃,” and “ptrs-MCS₄” may be indicated from the base station apparatus 100 to the user apparatus 200 through upper layer signaling, and predetermined values may be specified, or values obtained by adding an offset value to the threshold value may be used. The value of the density L_{PT-RS} in the time domain shown in Table 1 is an example, and the values in the right column of Table 1 may be changed to, for example, “PT-RS is not present,” 3, 2, and 1 or the like.

Table 2 illustrates a table specifying the PT-RS density in the frequency domain which is applied in the case of the “UCI on PUSCH.”

TABLE 2

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

“N_{RB0}” and “N_{RB1}” shown in Table 2 are threshold values for determining a density K_{PT-RS} in the frequency domain. As shown in Table 2, when the number of resource blocks “N_{RB}” scheduled as a PUSCH in which the UCI is transmitted is less than a threshold value “N_{RB0},” the PT-RS is not arranged. When “N_{RB}” is greater than or equal to the threshold value “N_{RB0}” and less than the threshold value “N_{RB1},” K_{PT-RS} is 2. When “N_{RB}” is greater than or equal to the threshold value “N_{RB1},” K_{PT-RS} is 4.

The threshold values “N_{RB0}” and “N_{RB1}” may be indicated from the base station apparatus 100 to the user apparatus 200 through upper layer signaling, and predetermined values may be specified, or values obtained by adding an offset value to the threshold value may be used. The value of the density K_{PT-RS} in the frequency domain shown in Table 2 is an example, and the values in the right column of Table 2 may be changed to, for example, “PT-RS is not present,” 1, and 2 or the like.

The user apparatus 200 may specify an offset value for “ptrs-MCSₙ” as “-X,” replace the value of “ptrs-MCSₙ” “ptrs-MCSₙ-X,” and perform the threshold value determination shown in Table 1. Similarly, the user apparatus 200 may specify an offset value for “N_{RBn}” as “−Y,” replace “N_{RBn}” with “N_{RBn-Y},” and perform the threshold value determination shown in Table 2.

As the offset value X, a value common to the threshold values “ptrs-MCS₁,” “ptrs-MCS₂,” “ptrs-MCS₃,” and “ptrs-MCS₄” may be used, or different values may be used. As the offset value Y, a value common to the threshold values “N_{RB0}” and “N_{RB1}” may be used, or different values may be used. The offset value X or the offset value Y may be indicated to the user apparatus 200 through upper layer signaling or specified in advance.

When the value of “ptrs-MCSₙ-X” is less than 0, 0 may be set, and when the value of “N_{RBrn}-Y” is less than 1, 1 may be set. When the value of “ptrs-MCSₙ-X” exceeds an upper limit defined by the MCS, the upper limit defined by the MCS may be set.

The user apparatus 200 may change the offset value X or the offset value Y in accordance with content of the UCI. For example, when the UCI includes a channel quality indicator (CQI), the offset value may be decreased, and when the UCI includes an ACK/NACK that is a hybrid automatic repeat request (HARQ) response, he offset value may be increased.

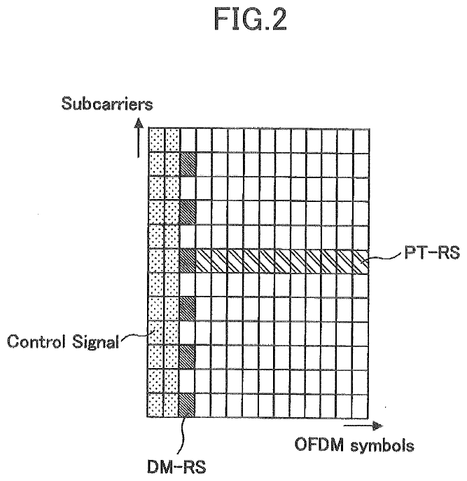

FIG. 2 is a diagram illustrating an example (1) in which the PT-RS is arranged in a physical resource in an embodiment of the present invention. A mapping format of the PT-RS and the OFDM symbol corresponding to the PT-RS density in the time domain will be described. In one slot illustrated in FIG. 2, symbols to the PT-RS is mapped among 14 OFDM symbols are illustrated. Resources in a symbol are delimited in units of subcarriers, and 12 subcarriers constitute one resource block. Hereinafter, a “symbol position” indicates a position in the time domain, and position indices for 14 symbols are symbols #0 to #13.

In the slot illustrated in FIG. 2, the PUSCH is arranged in a resource to which the DM-RS or the PT-RS is not allocated. FIG. 2 illustrates an example in which the PT-RSs are arranged consecutively in the symbols #3 to #13 in the time domain. At this time, the density L_{PT-RS} of the PT-RS in the time domain is 1. Here, the L_{PT-RS} is defined by intervals of symbols in which the PT-RS is arranged in the time domain of interest. In FIG. 2, since symbols in which one PT-RS is arranged in each of the symbols #3 to #13 of interest are arranged, the density L_{PT-RS} becomes 1.

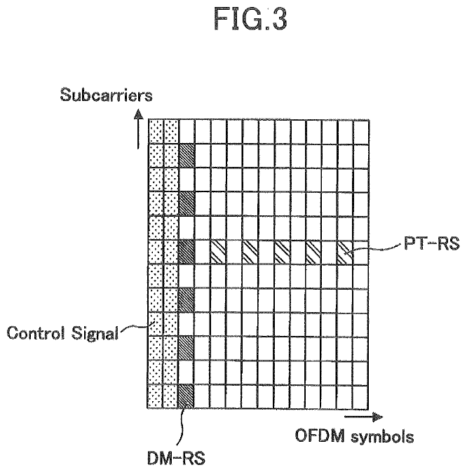

FIG. 3 is a diagram illustrating an example (2) in which the PT-RS is arranged in a physical resource in an embodiment of the present invention. A mapping format of the PT-RS and the OFDM symbol corresponding to the PT-RS density in the time domain will be described. In the slot illustrated in FIG. 3, the PUSCH is arranged in a resource to which the DM-RS or the PT-RS is not located. FIG. 3 illustrates an example in which the PT-RS is arranged for every two symbols in the symbols #3 to #13 in the time domain. In FIG. 3, since symbols in which one PT-RS is arranged for every two symbols in the symbols #3 to #13 of interest are arranged, the density L_{PT-RS} in the time domain is 2.

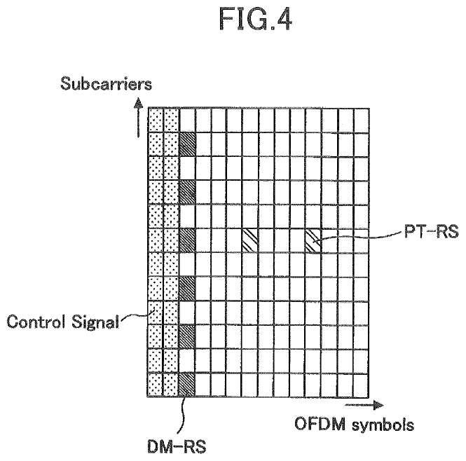

FIG. 4 is a diagram illustrating an example (3) in which the PT-RS is arranged in a physical resource in an embodiment of the present invention. A mapping format of the PT-RS and the OFDM symbol corresponding to the PT-RS density in the time domain will be described. In the slot illustrated in FIG. 4, the PUSCH is arranged in a resource to which the DM-RS or the PT-RS is not allocated. FIG. 4 illustrates an example in which the PT-RS is arranged for every four symbols in the symbols #3 to #13 in the time domain. In FIG. 4, since symbols in which one PT-RS is arranged for every four symbols in the symbols #3 to #13 of interest are arranged, the density L_{PT-RS} in the time domain is 4.

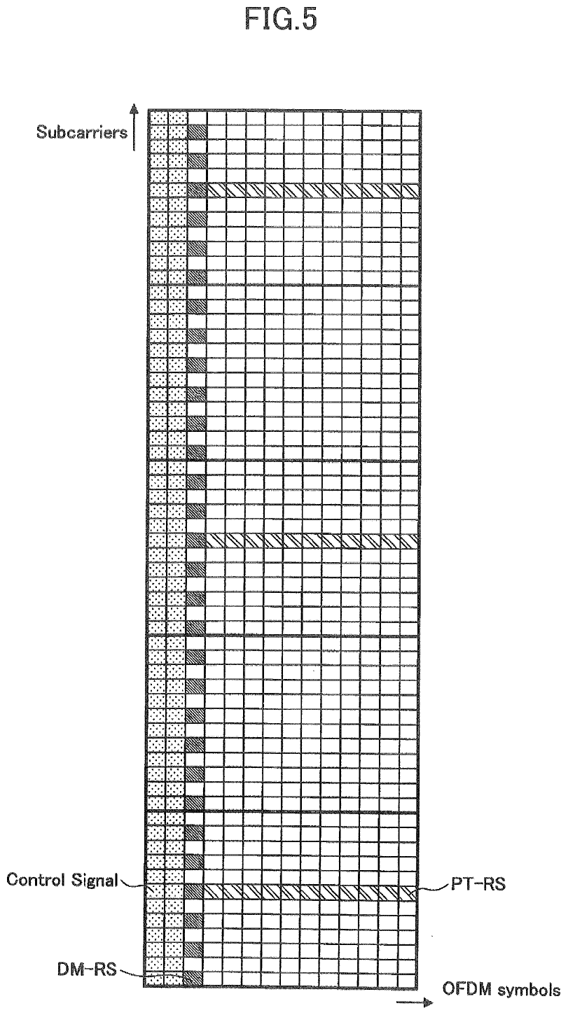

FIG. 5 is a diagram illustrating an example (4) in which the PT-RS is arranged in a physical resource in an embodiment of the present invention. A mapping format of the PT-RS and the OFDM symbol corresponding to the PT-RS density in the frequency domain will be described. In one slot illustrated in FIG. 5, five resource blocks each of which is constituted by 14 OFDM symbols and 12 subcarriers are illustrated, and a resource block to which the PT-RS is mapped is illustrated.

In the slot illustrated in FIG. 5, the PUSCH is allocated to a resource to which the DM-RS or the PT-RS is not allocated. FIG. 5 illustrates an example in which the PT-RS is consecutively arranged in the symbols #3 to #13 in the time domain from. In the frequency domain of the slot illustrated in FIG. 5, resource blocks in which the PT-RSs are allocated for every two resource blocks are arranged. At this time, the density K_{PT-RS} of the PT-RS in the frequency domain is 2. Here, K_{PT-RS} is defined by intervals of resource blocks in which the PT-RS is arranged in the frequency domain. In FIG. 5, since resource blocks in which one PT-RS is arranged for every two resource blocks are arranged, the density K_{PT-RS} is 2.

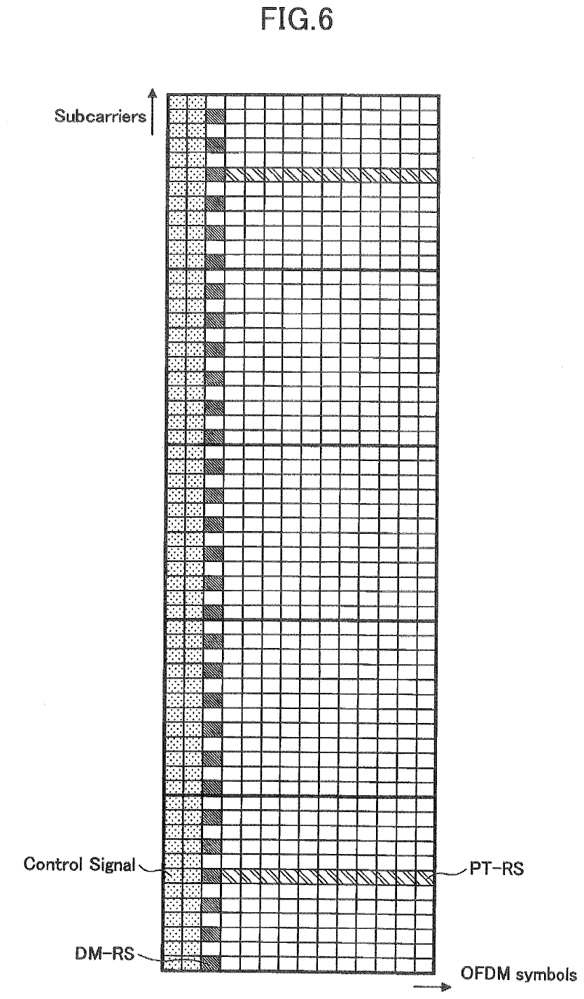

FIG. 6 is a diagram illustrating an example (5) in which the PT-RS is arranged in a physical resource in an embodiment of the present invention. A mapping format of the PT-RS and the OFDM symbol corresponding to the PT-RS density in the frequency domain will be described. In the slot illustrated in FIG. 6, the PUSCH is arranged in a resource to which the DM-RS or the PT-RS is not allocated. FIG. 6 illustrates an example in which the PT-RS is consecutively arranged in the symbols #3 to #13 in the time domain. In the frequency domain of the slot illustrated in FIG. 5, resource blocks in which the PT-RS is allocated for every four resource blocks are arranged. In FIG. 6, since resource blocks in which one PT-RS is arranged for every four resource blocks is arranged, the density K_{PT-RS} in the frequency domain is 4.

The density L_{PT-RS} in the time domain and the density K_{PT-RS} in the frequency domain are defined as described above, but these are examples, and other definitions may be used as long as they are values indicating the density with which the PT-RS is arranged in the physical resource.

In the case in which the arrangement of the PT-RS is configured through upper layer signaling, that is, in a case in which an information element “Uplink-PTRS-Config” in the upper layer is configured to ON (enable) and indicated, the arrangement of the PT-RS may be configured in the “UCI on PUSCH” as well, and in the case in which the arrangement of the PT-RS is not configured through upper layer signaling, that is, in a case in which an information element “Uplink-PTRS-Config” in the upper layer is configured to OFF (disable) and indicated, the arrangement of the PT-RS may not be configured. Further, an indication indicating whether or not the arrangement of the PT-RS is configured in the “UCI on PUSCH” may be indicated from the base station apparatus 100 to the user apparatus 200 through dedicated upper layer signaling designating whether or not the arrangement of the PT-RS is configured in the “UCI on PUSCH.”

The “UCI on PUSCH” in the above embodiment may be a case in which only the UCI is transmitted through the PUSCH or may be a case in which the UCI and the data are multiplexed and transmitted. The density with which the PT-RS is arranged in the physical resource may be different between the case in which only the UCI is transmitted through the PUSCH and the case in which the UCI and the data are multiplexed and transmitted. For example, the density in the case in which the UCI and the data are multiplexed and transmitted through the PUSCH may be caused to be lower than the case in which the density in the case in which only the UCI is transmitted through the PUSCH. Changing the density with which the PT-RS is arranged in the physical resource may be performed, for example, using different values as the threshold value “ptrs-MCSₙ” or the offset value X in Table 1. Changing the density with which the PT-RS is arranged in the physical resource may be performed, for example, using different values as the threshold value “N_{RBn}” or the offset value Y in Table 2.

Further, for example, upper layer signaling designating whether or not the arrangement of the PT-RS is configured may be different between the case in which only the UCI is transmitted through the PUSCH and the case in which the UCI and the data are multiplexed and transmitted through the PUSCH, and individual indications may be indicated from the base station apparatus 100 to the user apparatus 200.

In the above embodiment, the base station apparatus 100 and the user apparatus 200 can change the density in the time domain with which the PT-RS is arranged in the physical resource in the “UCI on PUSCH” by comparing a value obtained by adding the offset value to a predetermined threshold value with the MCS and change the density in the frequency domain with which the PT-RS is arranged in the physical resource by comparing a value obtained by adding the offset value to a predetermined threshold value with the number of scheduled resource blocks.

In other words, in the wireless communication system, when the control signal is transmitted in the data channel, an appropriate reference signal can be arranged in the data channel.

(Device Configuration)

Next, a functional configuration example of each of the base station apparatus 100 and the user apparatus 200 that execute the processes and the operation described so far will be described. Each of the base station apparatus 100 and the user apparatus 200 has at least the function of implementing the embodiment. Here, each of the base station apparatus 100 and the user apparatus 200 may have only some of the functions in the embodiment.

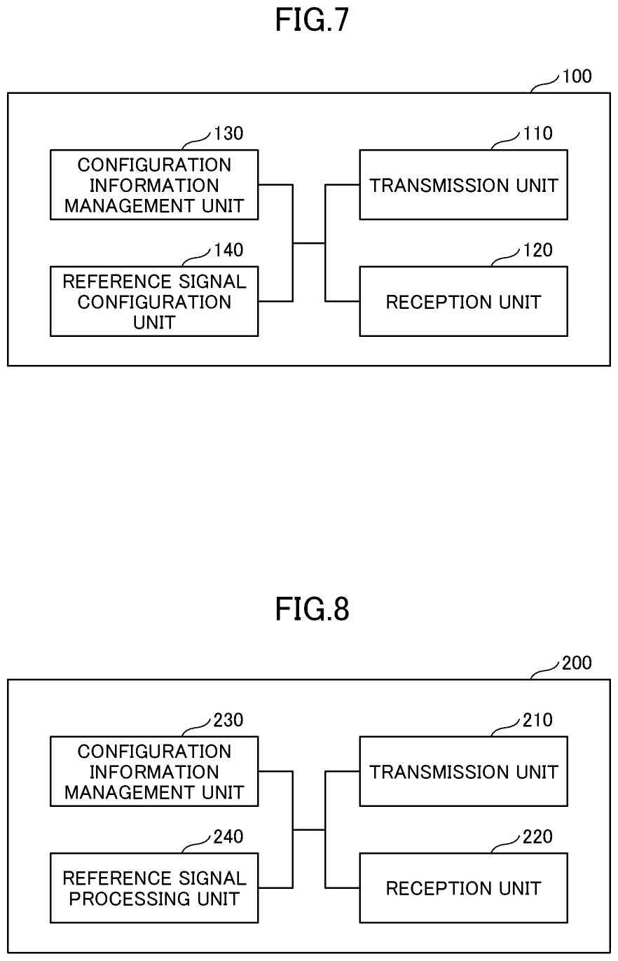

FIG. 7 is a diagram illustrating an example of a functional configuration of the base station apparatus 100. As illustrated in FIG. 7, the base station apparatus 100 has a transmitting unit 110, a reception unit 120, a configuration information management unit 130, and a reference signal configuration unit 140. The functional configuration illustrated in FIG. 7 is only an example. As long as the operation according to the embodiment of the present invention can be executed, the function classification and the name of the function unit are not consequential.

The transmission unit 110 has a function of generating a signal to be transmitted to the user apparatus 200 and transmitting the signal wirelessly. The reception unit 120 has a function of receiving various types of signals including the NR-PUSCH transmitted from the user apparatus 200 and acquiring, for example, information of a higher layer from the received signals. Further, the reception unit 120 demodulates the NR-PUSCH on the basis of the PT-RS received from the user apparatus 200. The transmission unit 110 has a function of transmitting the NR-PSS, the NR-SSS, the NR-PBCH, the NR-PDCCH, the NR-PDSCH, or the like to the user apparatus 200. Further, the transmission unit 110 transmits various types of reference signals, for example, the DM-RS or the like to the user apparatus 200.

The configuration information management unit 130 stores preconfigured configuration information and various types of configuration information to be transmitted to the user apparatus 200. For example, content of the configuration information is information related to the arrangement of the reference signal in the radio frame.

The reference signal configuration unit 140 configures various types of reference signals to be transmitted from the base station apparatus 100 to the user apparatus 200, for example, the DM-RS or the like, in the radio frame as described in the embodiment.

FIG. 8 is a diagram illustrating an example of a functional configuration of the user apparatus 200. As illustrated in FIG. 8, the user apparatus 200 has a transmission unit 210, a reception unit 220, a configuration information management unit 230, and a reference signal processing unit 240. The functional configuration illustrated in FIG. 8 is only an example. As long as the operation according to the embodiment of the present invention can be executed, the function classification and the name of the function unit are not consequential.

The transmission unit 210 generates a transmission signal from transmission data and transmits the transmission signal wirelessly. Further, the transmission unit 210 transmits signals including various types of reference signals, for example, the PT-RS and the NR-PUSCH corresponding to the PT-RS to base station apparatus 100. The reception unit 220 wirelessly receives various types of signals, and acquires a signal of a higher layer from a received signal of a physical layer. The reception unit 220 also has a function of receiving the NR-PSS, the NR-SSS, the NR-PBCH, the NR-PDCCH, the NR-PDSCH, or the like transmitted from the base station apparatus 100. Further, the transmission unit 210 transmits an uplink signal to the base station apparatus 100, and the reception unit 120 receives various types of reference signals, for example, the DM-RS, the PTRS, or the like from the base station apparatus 100. The configuration information management unit 230 stores various types of configuration information received from the base station apparatus 100 by the reception unit 220. The configuration information management unit 230 also stores preconfigured configuration information. For example, content of the configuration information is information related to the arrangement of the reference signal in the radio frame.

The reference signal processing unit 240 performs control related to an operation of receiving the reference signal in the user apparatus 200 described in the embodiment and using the reference signal for the channel estimation and the demodulation or the like. Further, the reference signal processing unit 240 arranges the PT-RS with the desired density in the physical resource when the UCI is transmitted through the NR-PUSCH. The function unit related to the transmission of the reference signal in the reference signal processing unit 240 may be included in the transmission unit 210, and the function unit related to the reception of the reference signal in the reference signal processing unit 240 may be included in the reception unit 220.

(Hardware Configuration)

In the functional configuration diagrams (FIGS. 7 and 8) used for the description of the embodiment of the present invention, the blocks of the functional units are illustrated. The functional blocks (configuring units) are implemented by an arbitrary combination of hardware and/or software. A device of implementing each functional block is not particularly limited. In other words, each functional block may be implemented by one device in which a plurality of elements are physically and/or logically combined or may be implemented by a plurality of devices, that is, two or more devices which are physically and/or logically separated and are directly and/or indirectly connected (for example, a wired and/or wireless manner).

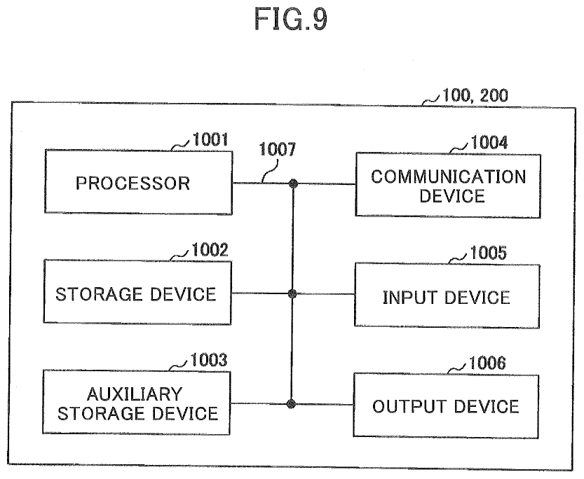

Further, for example, both the base station apparatus 100 and the user apparatus 200 in one embodiment of the present invention may function as a computer that performs the process according to the present invention. FIG. 9 is a diagram illustrating an example of a hardware configuration of a wireless communication device which is the base station apparatus 100 or the user apparatus 200 according to the embodiment of the present invention. Each of the base station apparatus 100 and the user apparatus 200 may be physically configured as a computer device including a processor 1001, a storage device 1002, an auxiliary storage device 1003, a communication device 1004, an input device 1005, an output device 1006, a bus 1007, and the like.

In the following description, the term “device” can be read as a circuit, device, unit, or the like. The hardware configuration of each of the base station apparatus 100 and the user apparatus 200 may be configured to include one or more devices indicated by 1001 to 1006 illustrated in the drawing or may be configured without including some devices.

Each function in each of the base station apparatus 100 and the user apparatus 200 is implemented such that predetermined software (program) is read on hardware such as the processor 1001 and the storage device 1002, and the processor 1001 performs an operation and controls communication by the communication device 1004 and reading and/or writing of data in the storage device 1002 and the auxiliary storage device 1003.

For example, the processor 1001 operates an operating system and controls the entire computer. The processor 1001 may be configured with a central processing unit (CPU) including an interface with a peripheral device, a control device, an operation device, a register, and the like.

Further, the processor 1001 reads a program (program code), a software module, or data from the auxiliary storage device 1003 and/or the communication device 1004 out to the storage device 1002, and executes various types of processes according to them. A program causing a computer to execute at least some of the operations described in the above embodiment is used as the program. For example, the transmission unit 110, the reception unit 120, the configuration information management unit 130, and the reference signal configuration unit 140 of the base station apparatus 100 illustrated in FIG. 7 may be implemented by a control program which is stored in the storage device 1002 and operates on the processor 1001. Further, for example, the transmission unit 210, the reception unit 220, the configuration information management unit 230, and the reference signal processing unit 240 of the user apparatus 200 illustrated in FIG. 8 may be implemented by a control program which is stored in the storage device 1002 and operates on the processor 1001. Various types of processes have been described as being performed by one processor 1001 but may be performed simultaneously or sequentially by two or more processors 1001. The processor 1001 may be implemented by one or more chips. The program may be transmitted from a network via an electric communication line.

The storage device 1002 is a computer readable recording medium and configured with at least one of a read only memory (ROM), an erasable programmable ROM (EPROM), an electrically erasable programmable ROM (EEPROM), a random access memory (RAM), and the like. The storage device 1002 is also referred to as a “register,” a “cache,” a “main memory,” or the like. The storage device 1002 can store programs (program codes), software modules, or the like which are executable for carrying out the radio communication method according to an embodiment of the present invention.

The auxiliary storage device 1003 is a computer-readable recording medium and may be configured with, for example, at least one of an optical disk such as a compact disc ROM (CD-ROM), a hard disk drive, a flexible disk, a magneto-optical disk (for example, a compact disk, a digital versatile disk, or a Blu-ray (registered trademark) disc, a smart card, a flash memory (for example, a card, a stick, or a key drive), a floppy (registered trademark) disk, a magnetic strip, and the like. The auxiliary storage device 1003 is also referred to as an “auxiliary storage device.” The storage medium may be, for example, a database, a server, or any other appropriate medium including the storage device 1002 and/or the auxiliary storage device 1003.

The communication device 1004 is hardware (a transceiving device) for performing communication between computers via a wired and/or wireless network and is also referred to as a “network device,” a “network controller,” a “network card,” a “communication module,” or the like. For example, the transmission unit 110 and the reception unit 120 of the base station apparatus 100 may be implemented in the communication device 1004. Further, the transmission unit 210 and the reception unit 220 of the user apparatus 200 may be implemented in the communication device 1004.

The input device 1005 is an input device that receives an input from the outside (such as a keyboard, a mouse, a microphone, a switch, a button, a sensor, or the like). The output device 1006 is an output device that performs an output to the outside (for example, a display, a speaker, an LED lamp, or the like). The input device 1005 and the output device 1006 may be integratedly configured (for example, a touch panel).

The respective devices such as the processor 1001 and the storage device 1002 are connected via the bus 1007 to communicate information with each other. The bus 1007 may be configured with a single bus or may be configured with different buses between the devices.

Further, each of the base station apparatus 100 and the user apparatus 200 may be configured to include hardware such as a microprocessor, a digital signal processor (DSP), an application specific integrated circuit (ASIC), a programmable logic device (PLD), or a field programmable gate array (FPGA) or all or some of the functional blocks may be implemented by hardware. For example, the processor 1001 may be implemented by at least one of these pieces of hardware.

### Conclusion of Embodiment

As described above, according to the embodiment of the present invention, provided is a user apparatus including a processing unit configured to determine a density with which a phase correction reference signal corresponding to a data channel including control information is arranged in a physical resource and a transmission unit configured to transmit a radio signal including a physical resource, in which the phase correction reference signal with the determined density and the data channel including the control information are arranged, to a base station apparatus.

With the above configuration, the user apparatus 200 can change the density with which the PT-RS is arranged in the physical resource in the “UCI on PUSCH.” In other words, in the wireless communication system, when the control signal is transmitted through the data signal channel, an appropriate reference signal can be arranged in the data signal channel.

A reception unit configured to receive information for determining the density with which the phase correction reference signal corresponding to the data channel including the control information is arranged in the physical resource from the base station apparatus may be further included. With this configuration, the user apparatus 200 can determine the density with which the PT-RS is arranged in the physical resource based on the information indicated from the base station apparatus 100.

The information for determining the density may include a threshold value for determining a density in a time domain, a threshold value for determining a density in a frequency domain, and an offset value applied to a threshold value. According to this configuration, based on the information indicated from the base station apparatus 100, the user apparatus 200 determine the density in the time domain or the density in the frequency domain with which the PT-RS is arranged in the physical resource on the basis of the threshold to which the offset value is applied.

The processing unit may determine a density with which a phase correction reference signal in a time domain is arranged in a physical resource based on a threshold value for determining a density in the time domain, a first offset value applied to the threshold value, and a modulation and coding scheme (MCS) and determine a density with which a phase correction reference signal in a frequency domain is arranged in a physical resource on the basis of a threshold value for determining a density in the frequency domain, a second offset value applied to the threshold value, and the number of resource blocks in which the data channel is arranged. With this configuration, the user apparatus 200 can change the density in the time domain with which the PT-RS is arranged in the physical resource in the “UCI on PUSCH” by comparing a value obtained by adding the offset value to a predetermined threshold value with the MCS and change the density in the frequency domain with which the PT-RS is arranged in the physical resource by comparing a value obtained by adding the offset value to a predetermined threshold value with the number of scheduled resource blocks.

The processing unit may determine the density with which the corresponding phase correction reference signal is arranged in the physical resource using different first offset values or different second offset values in a data channel including only the control information and a data channel in which the control information and data are multiplexed. With this configuration, the user apparatus 200 can arrange the PT-RS in the physical resource with different densities in a case in which only the UCI is transmitted through the PUSCH or in case in which the UCI and the data are multiplexed and transmitted through the PUSCH.

According to the embodiment of the present invention, provided is a base station apparatus including a transmission unit configured to transmit information for determining a density with which a phase correction reference signal corresponding to a data channel including control information is arranged in a physical resource to a user apparatus, a configuration unit configured to determine the density the which the phase correction reference signal is arranged in the physical resource based on information related to the density, and a reception unit configured to receive a radio signal including a physical resource in which the phase correction reference signal with the determined density and the data channel including the control information are arranged from the user apparatus.

With the above configuration, the base station apparatus 100 can change the density with which the PT-RS is arranged in the physical resource in the “UCI on PUSCH.” In other words, in the wireless communication system, when the control signal is transmitted through the data signal channel, an appropriate reference signal can be arranged in the data signal channel.

### Supplement of Embodiment

The exemplary embodiment of the present invention has been described above, but the disclosed invention is not limited to the above embodiments, and those skilled in the art would understand various modified examples, revised examples, alternative examples, substitution examples, and the like. In order to facilitate understanding of the invention, specific numerical value examples have been used for description, but the numerical values are merely examples, and certain suitable values may be used unless otherwise stated. The classification of items in the above description is not essential to the present invention. Matters described in two or more items may be combined and used as necessary, and a matter described in one item may be applied to a matter described in another item (unless inconsistent). The boundary between functional units or processing units in a functional block diagram does not necessarily correspond to the boundary between physical parts. Operations of a plurality of functional units may be performed physically by one component, or an operation of one functional unit may be physically performed by a plurality of parts. In the processing procedure described in the embodiments, the order of the processes may be changed as long as there is no inconsistency. For the sake of convenience of processing description, the user apparatus UE and the base station NB have been described using the functional block diagrams, but such devices may be implemented by hardware, software, or a combination thereof. Software executed by the processor included in the base station apparatus 100 according to the embodiment of the present invention and software executed by the processor included in the user apparatus 200 according to the embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate storage medium.

A notification (indication) of information is not limited to the aspect or embodiment described in this specification and may be given by any other method. For example, the notification of information may be given physical layer signaling (for example, downlink control information (DCI), uplink control information (UCI)), higher layer signaling (for example, radio resource control (RRC) signaling, medium access control (MAC) signaling, broadcast information (master information block (MIB), system information block (SIB)), other signals, or a combination thereof. Further, the RRC signaling may be referred to as an “RRC message” and may be, for example, an RRC connection setup message, an RRC connection reconfiguration message, or the like.

Each aspect and embodiment described in this specification is applicable to Long Term Evolution (LTE), LTE-Advance (LTE-A), SUPER 3G, IMT-Advanced, 4G, 5G, future radio access (FRA), W-CDMA (registered trademark), GSM (registered trademark), CDMA2000, ultra mobile broadband (UMB), IEEE 802.11 (Wi-Fi), IEEE 802.16 (WiMAX), IEEE 802.20, ultra-wideband (UWB), Bluetooth (registered trademark), and systems using any other appropriate systems and/or next generation systems expanded on the basis of the systems.

The processing procedures, the sequences, the flowcharts, and the like of the respective aspects/embodiments described in this specification may be reversed in order unless there is a contradiction. For example, the method described in this specification presents elements of various steps in an exemplary order and is not limited to a presented specific order.

In this specification, a specific action that is supposed to be performed by the base station apparatus 100 may be performed by an upper node in some cases. In the network including one or more network nodes including the base station apparatus, various operations performed for communication with the user apparatus 200 can be obviously performed by the base station and/or any network node (for example, an MME, an S-GW, or the like is considered, but it is not limited thereto) other than the base station apparatus 100 and/or the base station apparatus 100. The example in which the number of network nodes excluding the base station apparatus 100 is one has been described above, but a combination of a plurality of other network nodes (for example, an MME and an S-GW) may be provided.

Each aspect/embodiment described in this specification may be used alone, may be used in combination, or may be switched in association with execution.

The user apparatus 200 is also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or other appropriate terms, depending on those having skill in the art.

The base station apparatus 100 is also referred to as a Node B (NB), an enhanced Node B (eNB), gNB, a base station, or other appropriate terms, depending on those having skill in the art.

The term “determining” used in this specification may include a wide variety of actions. For example, “determining” may include, for example, events in which events such as judging, calculating, computing, processing, deriving, investigating, looking up (for example, looking up in a table, a database, or another data structure), or ascertaining are regarded as “determining.” Further, “determining” may include, for example, events in which events such as receiving (for example, receiving information), transmitting (for example, transmitting information), input, output, or accessing (for example, accessing data in a memory) are regarded as “determining.” Further, “determining” may include, for example, events in which events such as resolving, selecting, choosing, establishing, or comparing are regarded as “determining.” In other words, “determining” may include events in which a certain operation is regarded as “determining.”

A phrase “on the basis of” used in this specification is not limited to “on the basis of only” unless otherwise stated. In other words, a phrase “on the basis of” means both “on the basis of only” and “on the basis of at least.”

“Include,” “including,” and variations thereof are intended to be comprehensive, similarly to a term “equipped with (comprising)” as long as the terms are used in this specification or claims set forth below.

Furthermore, the term “or” used in this specification or claims set forth below is intended not to be an exclusive disjunction.

In the present disclosure, for example, when an article such as “a,” “an,” or “the” in English is added by a translation, such an article is assumed to include the plural unless it is obviously indicated that such an article does not include the plural.

In an embodiment of the present invention, the PT-RS is an example of a phase correction reference signal. The reference signal processing unit 240 is an example of a processing unit. The reference signal configuration unit 140 is an example of a configuration unit. The UCI is an example of control information. The PUSCH is an example of a data channel.

Although the present invention has been described above in detail, it is obvious to those having skill in the art that the present invention is not limited to the embodiments described in this specification. The present invention can be carried out as revisions and modifications without departing from the gist and scope of the present invention decided in claims set forth below. Therefore, the description of this specification is intended to be exemplary and does not have any restrictive meaning to the present invention.

### EXPLANATIONS OF LETTERS OR NUMERALS

100 BASE STATION APPARATUS
200 USER APPARATUS
110 TRANSMISSION UNIT
120 RECEPTION UNIT
130 CONFIGURATION INFORMATION MANAGEMENT UNIT
140 REFERENCE SIGNAL CONFIGURATION UNIT
200 USER APPARATUS
210 TRANSMISSION UNIT
220 RECEPTION UNIT
230 CONFIGURATION INFORMATION MANAGEMENT UNIT
240 REFERENCE SIGNAL PROCESSING UNIT
1001 PROCESSOR
1002 STORAGE DEVICE
1003 AUXILIARY STORAGE DEVICE
1004 COMMUNICATION DEVICE
1005 INPUT DEVICE
1006 OUTPUT DEVICE

1. A user apparatus comprising:
a processing unit configured to determine a density with which a phase correction reference signal corresponding to a data channel including control information is arranged in a physical resource; and
a transmission unit configured to transmit a radio signal including the physical resource, in which the phase correction reference signal with the determined density and the data channel including the control information are arranged, to a base station apparatus.

2. The user apparatus according to claim 1, further comprising a reception unit configured to receive information for determining the density, with which the phase correction reference signal corresponding to the data channel including the control information is arranged in the physical resource, from the base station apparatus.

3. The user apparatus according to claim 2, wherein the information for determining the density includes a threshold value for determining a density in a time domain, a threshold value for determining a density in a frequency domain, and an offset value applied to a threshold value.

4. The user apparatus according to claim 1, wherein the processing unit determines a density with which a phase correction reference signal in a time domain is arranged in a physical resource based on a threshold value for determining a density in the time domain, a first offset value applied to the threshold value and a modulation and coding scheme (MCS), and determines a density with which a phase correction reference signal in a frequency domain is arranged in a physical resource based on a threshold value for determining a density in the frequency domain, a second offset value applied to the threshold value, and a number of resource blocks in which the data channel is arranged.

5. The user apparatus according to claim 4, wherein the processing unit determines the density with which the corresponding phase correction reference signal is arranged in the physical resource using different first offset values or different second offset values depending on whether only control information is included in the data channel or control information and data are multiplexed in the data channel.

6. A base station apparatus comprising:
a transmission unit configured to transmit information for determining a density, with which a phase correction reference signal corresponding to a data channel including control information is arranged in a physical resource, to a user apparatus;
a configuration unit configured to determine the density with which the phase correction reference signal is arranged in the physical resource based on information related to the density; and
a reception unit configured to receive a radio signal including a physical resource, in which the phase correction reference signal with the determined density and the data channel including the control information are arranged, from the user apparatus.
